(19) United States
(12) Patent Application Publication
(10) Pub. No.: US 2025/0227454 A1
(43) Pub. Date: Jul. 10, 2025

(54) SHARED ATTRIBUTED ALIASING FOR SUBSCRIPTION PROFILES

(71) Applicant: T-Mobile USA, Inc., Bellevue, WA (US)

(72) Inventor: Vasu Krishnasami, Bellevue, WA (US)

(21) Appl. No.: 18/409,514

(22) Filed: Jan. 10, 2024

(51) Int. Cl. H04W 8/20; H04W 8/08

(52) U.S. Cl. CPC H04W 8/20; H04W 8/08

(57) ABSTRACT

A mobility management node and a subscription database of a telecommunications network are described herein. The mobility management node and subscription database receive a master subscription profile from a central repository. The master subscription profile includes data that is shared across subscribers. When registering a user equipment (UE) with the telecommunications network, the mobility management node can signal support for an alias for the master subscription profile to the subscription database. The alias is a representation of the master subscription profile that is smaller than the master subscription profile. The subscription database receives the signal of support for the alias and provides it to the mobility management node in place of the master subscription profile. In response to another message from a mobility management node that does not indicate support for an alias, the subscription database provides the master subscription profile.

### BACKGROUND

Traffic across transmission mechanisms of telecommunications networks has continued to increase. For example, traffic over wire/cable connecting core network nodes of the telecommunications network has increased as both data plane and control plane traffic have increased. Control plane traffic, including messaging involving registrations for user equipment (UE), often involves transmission of redundant data. The subscription database of the core network may transmit a set of attributes to a mobility management node for each UE registration, and many of those attributes may be the same across a group of UEs.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIGS. 1A-1B are diagrams of a telecommunications network. FIG. 1A transmits a full subscription profile for each UE registration from the subscriber database to the mobility management node. FIG. 1B reduces use of a transmission mechanism between nodes of a telecommunications network by sending an alias in place of a full subscription profile and caching a master subscription profile which includes data that is shared across subscribers at nodes of the telecommunications network.

FIG. 2 is a flow diagram of an illustrative process at a mobility management node of a telecommunications network for receiving and caching a master subscription profile, signaling, to a subscription database, support for an alias of the master subscription profile, and receiving, from the subscription database, the alias in place of the master subscription profile.

FIG. 3 is a flow diagram of an illustrative process at a subscription database of a telecommunications network for receiving a master subscription profile, receiving messages from a mobility management node associated with UE registrations, and providing either a master subscription profile or an alias in place of that master subscription profile in response to each message.

FIG. 4 is a schematic diagram of a computing device capable of implementing functionality of at least one of the mobility management node or the subscription database.

### DETAILED DESCRIPTION

This disclosure is directed in part to a mobility management node and a subscription database of a telecommunications network. The mobility management node and subscription database receive a master subscription profile from a central repository. The master subscription profile includes data that is shared across subscribers. When registering a user equipment (UE) with the telecommunications network, the mobility management node can signal support for an alias for the master subscription profile to the subscription database. The alias is a representation of the master subscription profile that is smaller than the master subscription profile. The subscription database receives the signal of support for the alias and provides it to the mobility management node in place of the master subscription profile. In response to another message from a mobility management node that does not indicate support for an alias, the subscription database provides the master subscription profile.

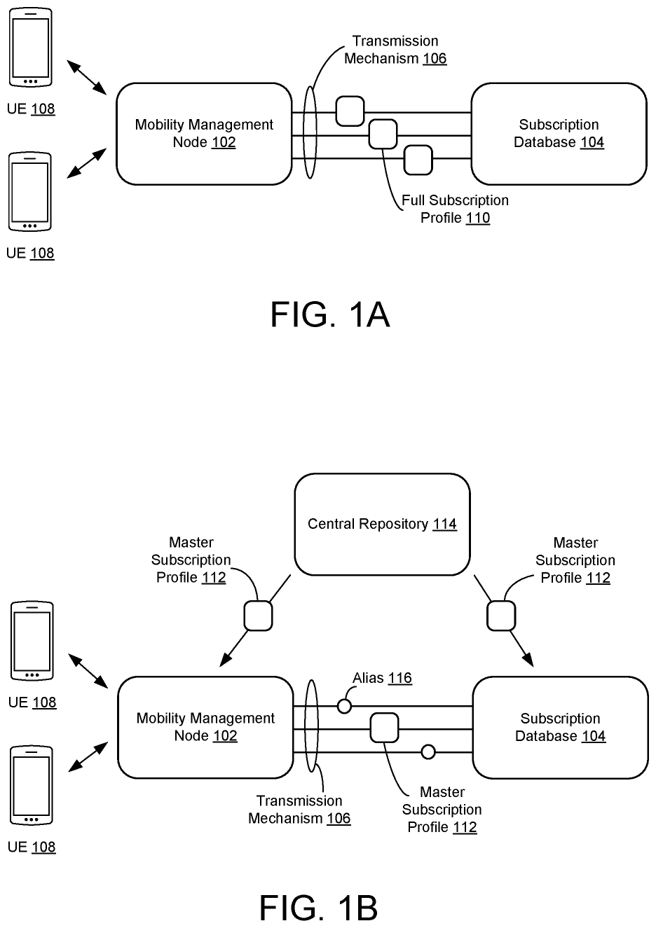

FIGS. 1A-1B are diagrams of a telecommunications network. FIG. 1A shows transmission of a full subscription profile from the subscriber database to the mobility management node responsive to each UE registration. As illustrated, a mobility management node 102 of a telecommunications network is connected to a subscription database 104 by a transmission mechanism 106. UE(s) 108 are connected to the mobility management node 102 through, e.g., radio access network(s). As part of registration of the UE(s) 108 with the telecommunications network, the mobility management node 102 transmits a request for each UE registration to the subscription database 104 over the transmission mechanism 106. The subscription database 104 responds to each request with a full subscription profile 110, also using the transmission mechanism 106. Because much of each full subscription profile is the same as the other full subscription profiles 110, there can be significant amounts of redundant data congesting the transmission mechanism 106.

FIG. 1B, in contrast, illustrates reduced use of the transmission mechanism between nodes of a telecommunications network by sending an alias in place of a full subscription profile and caching a master subscription profile which includes data that is shared across subscribers at nodes of the telecommunications network. As shown, a mobility management node 102 receives a master subscription profile 112 from a central repository 114 of the telecommunications network. The subscription database 104 also receives the master subscription profile 112 and an indication of an alias 116 which represents the master subscription profile 112. Upon processing a UE registration from a UE 108, the mobility management node 102 sends a request to the subscription database 104 and signals support for the alias 116. In response, the subscription database 104 transmits the alias 116 in place of the master subscription profile 112, thereby using fewer of the resources of the transmission mechanism 106.

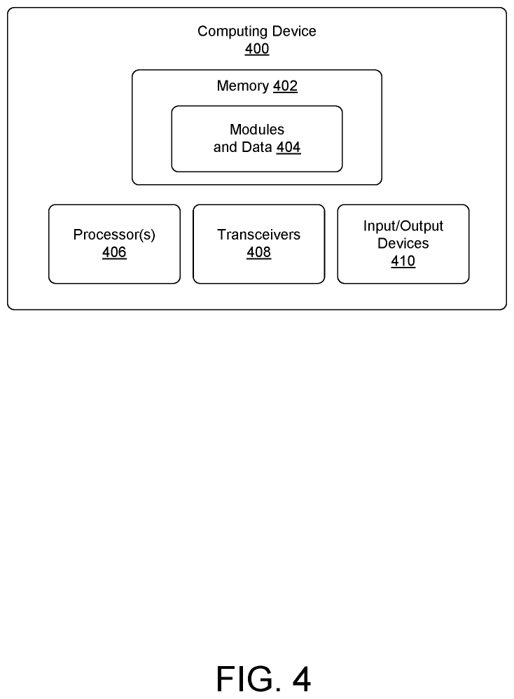

In various implementations, a telecommunications network such as is illustrated in FIGS. 1A-1B includes one or more mobility management nodes 102 as part of a core network. The telecommunications network also includes access networks to wirelessly connect to UEs, such as UEs 108, and one or more transmission mechanisms, such as transmission mechanism 106, that connect access networks to core network nodes and core network nodes to each other. The core network nodes may each be implemented on multiple computing devices, may each be implemented on its own computing device, may be co-implemented with other core network node(s) on a same computing device, or any combination of these. FIG. 4 illustrates an example computing device that can implement the mobility management node 102. The subscription database 104 can also be implemented by a computing device such as is shown in FIG. 4.

The mobility management node 102 supports mobility session management for the telecommunications network, including subscriber authentication, roaming, and handovers. It operates in the control plane of the telecommunications network, working to establish and maintain the underlying session that enables data transmission over the data plane. If the telecommunications network is a fifth generation (5G) network, the mobility management node 102 may be an access and mobility management function (AMF). If the telecommunications network is a fourth generation (4G) network, the mobility management node 102 may be a mobility management entity (MME). The mobility management node 102 is not limited to 4G or 5G networks, however, but may be associated with earlier or later generations of network (e.g., sixth generation (6G) networks, third generation (3G) networks, etc.).

The subscription database 104 is the main database for subscriber-related information for the telecommunications network, storing information about subscribers, their devices, and their services. In various implementations, among the subscriber information maintained by the subscription database 104 are information such as the full subscription profile 110, the master subscription profile 112, unique information about a subscriber, and/or alias 116. If the telecommunications network is a 5G network, the subscription database 104 may be unified data management (UDM). If the telecommunications network is a 4G network, the subscription database 104 may be a home subscriber server (HSS). The subscription database 104 is not limited to 4G or 5G networks, however, but may be associated with earlier or later generations of network (e.g., 6G networks, 3G networks, etc.).

In various implementations, the transmission mechanism 106 can be any kind of communication mechanism, whether wired, wireless, or a combination of the two. The transmission mechanism 106 includes a backhaul connecting the mobility management node 102 and subscription database 104 and can include components owned and operated by the network operator of the telecommunications network, components leased by that network operator, or both. As the transmission mechanism 106 may include leased components, it may be scaled without requiring building of additional infrastructure to support additional traffic. Doing so, however, comes at additional cost that a network operator may desire to avoid, as discussed herein. Examples of transmission mechanism 106 may include Ethernet, fiberoptic cables, etc.

The UEs 108 may each be any sort of UE, such as a cellular phone, a mobile device, a watch, goggles, an Internet-of-Things device (e.g., a wearable device, etc.), a tablet computer, a personal computer (PC), or any sort of device capable of wireless connectivity to one or more access points and of being moved from location to location. UEs 108 may connect to different radio access networks or ratio access technologies of the telecommunications network as they move from place to place, as attributes of their connections change, or as they change services utilized. With such changes, the UEs 108 send additional registrations through the mobility management node 102, which in turn result in control plane traffic between the mobility management node 102 and subscription database 104 over the transmission mechanism 106.

FIG. 1A shows the control plane traffic over the transmission mechanism 106 when full subscription profiles 110 are transmitted responsive to each UE registration. Since such registrations can include handovers triggered by movement, service quality, or type of service usage, even a single UE 108 can cause a great many UE registrations and responses to those registrations, from the subscription database, with the full subscription profile 110.

The full subscription profile 110 may include both information unique to a subscriber, such as a mobile station international subscriber directory number (MSISDN) or an international mobile subscriber identity (IMSI), and information that is shared among multiple subscribers, such as an access point name (APN), a quality-of-service (QOS), a radio access restriction type, a maximum bandwidth, or a speed. Upon receiving an identifier for the UE 108 or subscriber associated with the UE 108, the subscription database 104 may retrieve the information constituting the full subscription profile 110 and transmit it to the requestor (in FIG. 1A, the mobility management node 102). Because many subscribers may have the same shared parts of their subscription profiles, much of the transmission shown in FIG. 1A may be of redundant data.

FIG. 1B shows an alternative to transmitting the full subscription profile 110 every time a UE registration request is received: the use of a master subscription profile 112 and an alias 116 for the master subscription profile 112. As shown, a central repository 114 of the telecommunications network can distribute a master subscription profile 112 to the mobility management node 102 and subscription database 104 and participate in refreshing the master subscription profile 112. The central repository 114 may also notify the mobility management node 102 and subscription database 104 of the alias for the master subscription profile 112. In some examples, the central repository 114 may be a billing server of the telecommunications network, a network function, etc. In one example, the central repository 114 may be the same as the subscription database 104.

When the mobility management node 102 and subscription database 104 receive the master subscription profile 112, they may cache the master subscription profile 112. Periodically, they may refresh the master subscription profile 112, either in a pulled fashion, with the mobility management node 102 and subscription database 104 requesting the master subscription profile 112, or in a pushed manner, receiving the master subscription profile 112 from the central repository 114 without requesting it.

In various implementations, the master subscription profile 112 may include information that is shared among multiple subscribers. It may include a set of information that is shared among all subscribers to a service plan of the telecommunications network. Alternatively, it may be more specific, such as covering UEs 108 that share a specific APN and QoS pair. As noted herein, the master subscription profile 112 can include an APN, a QoS, a radio access restriction type, a maximum bandwidth, or a speed. The master subscription profile 112 may comprise the part of the full subscription profile 110 that is not considered information unique to a subscriber.

In various implementations, UEs 108 may be connected to the mobility management node 102. When one of the UEs 108 changes a location, experiences a different service quality, or uses a different type of service, that UE 108 may connect to or be handed over to a different radio access network, resulting in a new UE registration. Upon receiving the UE registration, the mobility management node 102 sends a request to the subscription database 104 for subscriber information. Based on whether or not the UE 108 is associated with a master subscription profile 112 such that the mobility management node 102 supports an alias 116 for the master subscription profile 112, the mobility management node 102 sends, with the request, an indication of whether the alias 116 is supported.

The subscription database 104 receives the requests from the mobility management node 102 and determines, for each, whether it indicates support for an alias 116. If support for an alias 116 is indicated, the subscription database 104 responds with the alias 116 (and if there are multiple aliases for multiple master subscription profiles, responds with the appropriate alias 116) and with information unique to the subscriber associated with the UE 108, such as a MSISDN or IMSI. If support for an alias 116 is not indicated, the subscription database 104 responds with the master subscription profile 112 and unique information (in some implementations, the combination of the master subscription profile 112 and unique information may be the same as the full subscription profile 110).

In some implementations, other considerations may determine whether or not the mobility management node 102 indicates support for an alias 116. For instance, the mobility management node 102 may receive a threshold from the central repository 114 or other source for cache utilization. If the threshold is met (e.g., the cache exceeds a threshold), the mobility management node 102 may delete the master subscription profile 112 and not indicate alias support, thus resulting in receiving the master subscription profile 112/full subscription profile 110 over the transmission mechanism 106. Such techniques may help an operator of the telecommunications network to balance cache utilization and utilization of the transmission mechanism 106. Additionally, if the mobility management node 102 experiences more than a threshold number of failures, the mobility management node 102 may indicate that it does not support the alias 116.

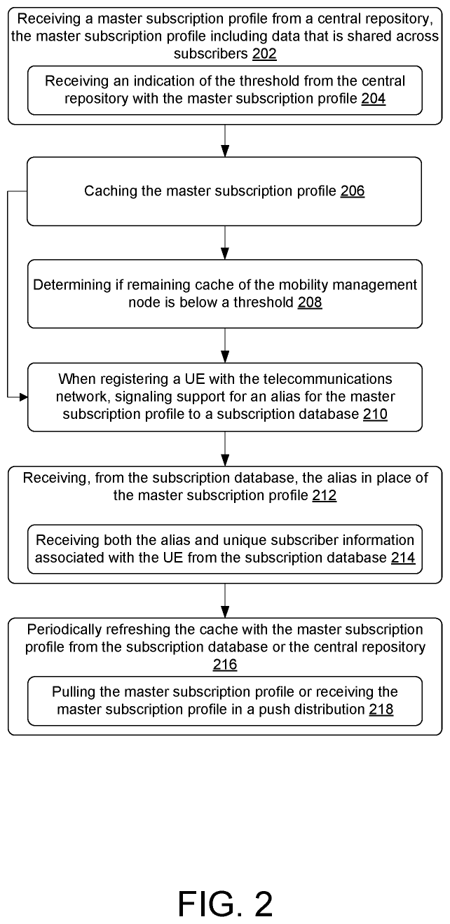

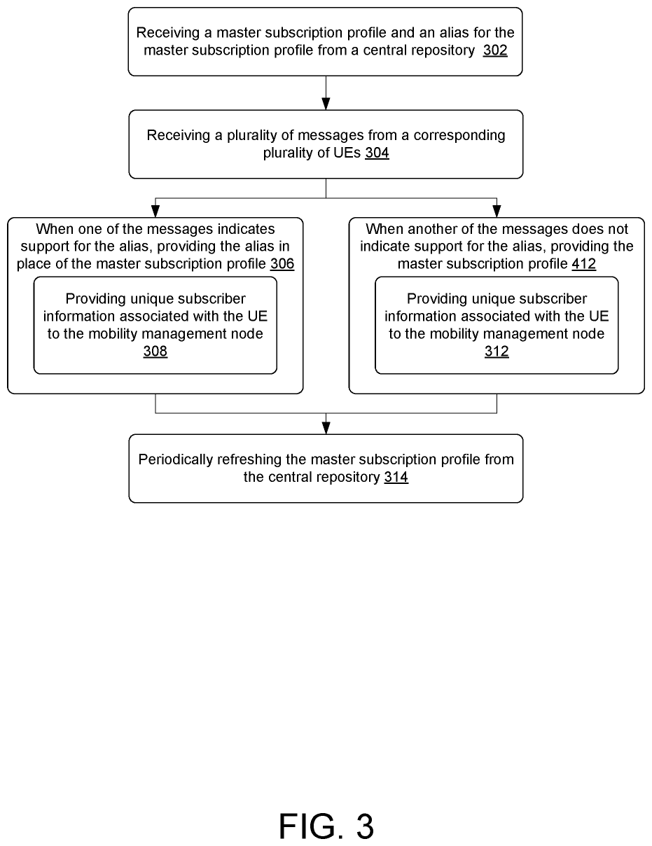

FIGS. 2-3 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 2 is a flow diagram of an illustrative process at a mobility management node of a telecommunications network for receiving and caching a master subscription profile, signaling, to a subscription database, support for an alias of the master subscription profile, and receiving, from the subscription database, the alias in place of the master subscription profile.

As illustrated at 202, a mobility management node of a telecommunications network receives a master subscription profile from a central repository of the telecommunications network. The master subscription profile includes data that is shared across subscribers. Also, the master subscription profile may include at least one of an access point name (APN), a quality-of-service (QOS), a radio access restriction type, a maximum bandwidth, a speed, steering of roaming (SOR), shared data, or context data. Additionally or alternatively, the master subscription profile may include any of the attributes from any of Third Generation Partnership Project (3GPP) Specifications 29.002, 29.272, or 29.505. In some implementations, at 204, the mobility management node may also receive an indication of the threshold from the central repository along with the master subscription profile. Further, the master subscription profile may be common to UEs associated with a common service plan or to UEs that are associated with a specific access point name (APN) and quality-of-service (QOS) pair.

At 206, the mobility management node caches the master subscription profile.

At 208, in some implementations, the mobility management node may determine if remaining cache of the mobility management node is below a threshold, such as a threshold received with the master subscription profile.

At 210, when registering a UE with the telecommunications network, the mobility management node signals support for an alias for the master subscription profile to a subscription database of the telecommunications network. In some implementations, signaling the support for the alias may be performed conditionally based on whether a remaining cache of the mobility management node is below the threshold.

At 212, the mobility management node receives, from the subscription database, the alias in place of the master subscription profile. At 214, receiving the alias may comprise receiving both the alias and unique subscriber information associated with the UE from the subscription database. The unique subscriber information includes at least one of a mobile station international subscriber directory number (MSISDN) or an international mobile subscriber identity (IMSI).

At 216, the mobility management node may periodically refresh the cache with the master subscription profile from the subscription database or the central repository. At 218, periodically refreshing the cache may comprise pulling the master subscription profile from the subscription database or the central repository or receiving the master subscription profile in a push distribution from the subscription database or the central repository. The periodic refreshing at 216 or 216 and 218 may occur before, during, and/or after any of operations 202-214.

Further, in various implementations, when the telecommunications network is a 5G network, the mobile management node is an AMF and the subscription database is a UDM. When the telecommunications network is a 4G network, the mobile management node is a MME and the subscription database is a HSS.

FIG. 3 is a flow diagram of an illustrative process at a subscription database of a telecommunications network for receiving a master subscription profile, receiving messages from a mobility management node associated with UE registrations, and providing either a master subscription profile or an alias in place of that master subscription profile in response to each message.

As illustrated at 302, the subscription database receives a master subscription profile and an alias for the master subscription profile from a central repository of the telecommunications network. The master subscription profile including data that is shared across subscribers. Also, the master subscription profile may include at least one of an access point name (APN), a quality-of-service (QOS), a radio access restriction type, a maximum bandwidth, or a speed. Further, the master subscription profile may be common to UEs associated with a common service plan or to UEs that are associated with a specific access point name (APN) and quality-of-service (QOS) pair. In some implementations, the alias may be a representation of the master subscription profile that is smaller than the master subscription profile.

At 304, the subscription database receives, from a mobility management node of the telecommunications network, a plurality of messages from a corresponding plurality of UE.

At 306, when one of the messages indicates support for the alias, the subscription database provides the alias in place of the master subscription profile. At 308, the subscription database may also provide unique subscriber information associated with the UE to the mobility management node.

At 310, when another of the messages does not indicate support for the alias, the subscription database provides the master subscription profile. At 312, the subscription database may also provide unique subscriber information associated with the UE to the mobility management node.

At 314, the subscription database may periodically refresh the master subscription profile from the central repository. The periodically refreshing at 314 may occur before, during, and/or after any of operations 302-312.

Further, in various implementations, when the telecommunications network is a 5G network, the mobile management node is an AMF and the subscription database is a UDM. When the telecommunications network is a 4G network, the mobile management node is a MME and the subscription database is a HSS.

FIG. 4 is a schematic diagram of a computing device capable of implementing functionality of at least one of the mobility management node or the subscription database. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the mobility management node 102, subscription database 104, any other node/device described and illustrated herein. Further, when the computing device 500 is a mobility management node 102 or a subscription database 104, the modules and data 504 may include a master subscription profile 112 or an alias 116.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
receiving, by a mobility management node of a telecommunications network, a master subscription profile from a central repository of the telecommunications network, the master subscription profile including data that is shared across subscribers;
caching, by the mobility management node in a cache of the mobility management node, the master subscription profile;
when registering a user equipment (UE) with the telecommunications network, signaling, by the mobility management node, support for an alias for the master subscription profile to a subscription database of the telecommunications network; and
receiving, by the mobility management node and from the subscription database, the alias in place of the master subscription profile.

2. The method of claim 1, wherein the master subscription profile includes at least one of an access point name (APN), a quality-of-service (QOS), a radio access restriction type, a maximum bandwidth, a speed, steering of roaming (SOR), shared data, or context data.

3. The method of claim 1, wherein the master subscription profile is common to UEs associated with a common service plan or to UEs that are associated with a specific access point name (APN) and quality-of-service (QOS) pair.

4. The method of claim 1, wherein receiving the alias comprises receiving both the alias and unique subscriber information associated with the UE from the subscription database, the unique subscriber information including at least one of a mobile station international subscriber directory number (MSISDN) or an international mobile subscriber identity (IMSI).

5. The method of claim 1, further comprising periodically refreshing the cache with the master subscription profile from the subscription database or the central repository.

6. The method of claim 5, wherein periodically refreshing the cache comprises pulling the master subscription profile from the subscription database or the central repository or receiving the master subscription profile in a push distribution from the subscription database or the central repository.

7. The method of claim 1,
wherein the telecommunications network is a fifth generation (5G) network, the mobility management node is an access and mobility management function (AMF), and the subscription database is a unified data management (UDM); or
wherein the telecommunications network is a fourth generation (4G) network, the mobility management node is a mobility management entity (MME), and the subscription database is a home subscriber server (HSS).

8. The method of claim 1, further comprising determining if remaining cache of the mobility management node is below a threshold,
wherein signaling the support for the alias is performed conditionally based on whether the remaining cache is below the threshold.

9. The method of claim 8, further comprising receiving an indication of the threshold from the central repository with the master subscription profile.

10. A system comprising:
one or more processors; and
a plurality of programming instructions that, when executed by the one or more processors, cause a subscription database of a telecommunications network to perform operations including:
receiving a master subscription profile and an alias for the master subscription profile from a central repository of the telecommunications network, the master subscription profile including data that is shared across subscribers;
receiving, from a mobility management node of the telecommunications network, a plurality of messages from a corresponding plurality of user equipment (UE);
when one of the messages indicates support for the alias, providing the alias in place of the master subscription profile; and
when another of the messages does not indicate support for the alias, providing the master subscription profile.

11. The system of claim 10, wherein the master subscription profile includes at least one of an access point name (APN), a quality-of-service (QOS), a radio access restriction type, a maximum bandwidth, or a speed.

12. The system of claim 10, wherein the master subscription profile is common to UEs associated with a common service plan or to UEs that are associated with a specific access point name (APN) and quality-of-service (QOS) pair.

13. The system of claim 10, wherein providing the alias or the master subscription profile comprises also providing unique subscriber information associated with the UE to the mobility management node, the unique subscriber information including at least one of a mobile station international subscriber directory number (MSISDN) or an international mobile subscriber identity (IMSI).

14. The system of claim 10, wherein the operations include periodically refreshing the master subscription profile from the central repository.

15. The system of claim 10,
wherein the telecommunications network is a fifth generation (5G) network, the mobility management node is an access and mobility management function (AMF), and the subscription database is a unified data management (UDM); or
wherein the telecommunications network is a fourth generation (4G) network, the mobility management node is a mobility management entity (MME), and the subscription database is a home subscriber server (HSS).

16. A non-transitory computer storage medium having a plurality of programming instructions stored thereon that, when executed by one or more processors, cause a mobility management node of a telecommunications network to perform operations comprising:
receiving a master subscription profile from a central repository of the telecommunications network, the master subscription profile including data that is shared across subscribers;
caching, in a cache of the mobility management node, the master subscription profile;
when registering a user equipment (UE) with the telecommunications network, signaling support for an alias for the master subscription profile to a subscription database of the telecommunications network; and
receiving, from the subscription database, the alias in place of the master subscription profile.

17. The non-transitory computer storage medium of claim 16, wherein the master subscription profile includes at least one of an access point name (APN), a quality-of-service (QoS), a radio access restriction type, a maximum bandwidth, or a speed.

18. The non-transitory computer storage medium of claim 16, wherein receiving the alias comprises receiving both the alias and unique subscriber information associated with the UE from the subscription database, the unique subscriber information including at least one of a mobile station international subscriber directory number (MSISDN) or an international mobile subscriber identity (IMSI).

19. The non-transitory computer storage medium of claim 16, wherein the operations further comprise periodically refreshing the cache with the master subscription profile from the subscription database or the central repository.

20. The non-transitory computer storage medium of claim 16, wherein the operations further comprise determining if remaining cache of the mobility management node is below a threshold,
wherein signaling the support for the alias is performed conditionally based on whether the remaining cache is below the threshold.
